(19) United States
(12) Patent Application Publication
(10) Pub. No.: US 2006/0061112 A1
(43) Pub. Date: Mar. 23, 2006

(54) Load-carrying device

(75) Inventor: Andre Schon, Bochum (DE)

Correspondence Address: HENRY M FEIEREISEN, LLC, 350 FIFTH AVENUE, SUITE 4714, NEW YORK, NY, 10118, US

(73) Assignee: YALE INDUSTRIAL PRODUCTS GMBH, Velbert (DE)

(21) Appl. No.: 11/032,687

(22) Filed: Jan. 10, 2005

(30) Foreign Application Priority Data
Sep. 23, 2004 (DE) 10 2004 046 523.1

(51) Int. Cl. B66C 1/48

(52) U.S. Cl. 294/101

(57) ABSTRACT

A load-carrying device, in particular a plate gripper for vertical transport of a plate includes a housing in which a fixed jaw is received and a clamping jaw is supported for movement relative to the fixed jaw. Both fixed and clamping jaws have a profiled gripping surface which is provided with a metallic surface coating containing at least one metal or metal carbide selected from the group consisting of molybdenum (Mo), tungsten (W), chromium (Cr), nickel (Ni), cobalt (Co), at a fraction of at least 50% by weight.

### CROSS-REFERENCES TO RELATED APPLICATIONS

This application claims the priority of German Patent Application, Serial No. 10 2004 046 523.1, filed Sep. 23, 2004, pursuant to 35 U.S.C. 119(a)-(d).

### BACKGROUND OF THE INVENTION

The present invention relates, in general, to a load-carrying device, and more particularly to a plate gripper for vertical transport of sheet metal plates.

It is to be understood by persons skilled in the art that the term “load-carrying device” is used here in a generic sense and the principles described in the following description with respect to a plate gripper, also referred to as lifting clamp, are equally applicable to any other type of load-carrying device which uses clamping or friction engagement for lifting a load. Examples of other load-carrying devices include tongs, clamps and other grippers.

Nothing in the following discussion of the state of the art is to be construed as an admission of prior art.

A plate gripper is used to lift and transport a sheet metal plate (hereinafter referred to as “plate”) and has a housing for accommodating a fixed jaw and a clamping jaw which is moveable relative to the fixed jaw. The gripper is lowered from above onto the plate so that the upper edge region of the plate is received in the mouth of the gripper between the fixed and clamping jaws and clamped by a spring force that urges the clamping jaw against the fixed jaw via a lever. The gripper has a shackle formed with a hook eye and thus can be pulled upwards by a hoist, e.g. crane, which applies a lifting force on the shackle. As a lifting force is applied, the shackle moves relative to the gripper housing, whereby a pin is shifted in a slot extending in lifting direction to pivot the clamping jaw via a link. As a result, the clamping jaw is moved substantially perpendicular to the lifting direction toward the opposite fixed jaw to thereby clamp the plate between the fixed and clamping jaws. An example of such a plate gripper is disclosed in U.S. Pat. No. 4,162,804 to Davies.

In order to be reliable in operation, the load-carrying device has to firmly grab an article to carry out a safe transport. The firmer the grip of the plate, the safer the transport. Therefore, the fixed jaw and the clamping jaw are each provided with a series of teeth on their gripping surface. When intended to lift a plate of very hard material, or articles that are greasy or oily, conventional grippers lose their holding force. The same is true, when articles have a very smooth or polished surface, such as, e.g., articles of special steel or with varnished surfaces. As a consequence, the transport of such articles causes problems and safety concerns.

It would therefore be desirable and advantageous to provide an improved load-carrying device to obviate prior art shortcomings.

### SUMMARY OF THE INVENTION

According to one aspect of the present invention, a load-carrying device, in particular plate gripper for vertical transport of a plate, includes a housing, a fixed jaw received in the housing and having a profiled gripping surface, and a clamping jaw supported in the housing for movement relative to the fixed jaw and having a profiled gripping surface, wherein the gripping surfaces of the fixed and clamping jaws are each provided with a metallic surface coating containing at least one metal or metal carbide selected from the group consisting of molybdenum (Mo), tungsten (W), chromium (Cr), nickel (Ni), cobalt (Co) at a fraction of at least 50% by weight.

The present invention resolves prior art problems by coating the profiled gripping surfaces of the fixed and clamping jaws with at least one metal or metal carbide, as set forth above. Such a surface coating improves the surface roughness of the gripping surfaces and increases the initial friction between the gripping surfaces and a plate during the lifting process. As a result, the holding capability of the load-carrying device and the ability for the article to stay on the load-carrying device are greatly enhanced. In particular, greasy or oily plates can now be transported more safely. Even the transport of very hard plates up to 37 HRC (Rockwell hardness C) and above is safe, as is the transport of thin or lightweight plates. The increase in the initial friction is especially beneficial on the gripping surfaces. Tests have shown that the gripping spot during lifting of a load can be reached faster compared to grippers with jaws of conventional construction. The “slip effect” is reduced, without experiencing any adverse affects on the material of the plate, when the jaws grip the plate.

Another advantage of a load-carrying device according to the invention is the increased wear resistance and longer life of the jaws and their gripping surfaces. The surface coating provides an effective protection of the base material of the jaws which may suffer adverse consequences only after the surface coating has worn off but can then easily be reconditioned or replaced. The provision of a surface coating upon the jaws in accordance with the present invention has the added benefit of reducing electrochemical differences in potential as a result of the different materials between the jaws, on one hand, and the plates to be transported, on the other hand so that potential corrosive effects are of less concern. This applies in particular in case of plates made of special steel because special steel and the metallic surface coating are less apart in the electrochemical series. In other words, the difference in potential between both these materials is smaller.

According to another feature of the present invention, the fixed and clamping jaws may have a base material made of case-hardened steel. This type of steel is carbonized and has a hardness of 55 to 58 HRC. The surface coating is then applied onto this base material and should have a hardness of 60 HRC or above.

According to another feature of the present invention, the fraction of metal is between 80% by weight and 95% by weight. Currently preferred is a fraction of metal of about 90% by weight.

Currently preferred is a surface coating made of molybdenum or a molybdenum alloy, in particular a surface coating with a molybdenum fraction of about 90% by weight. Tests have shown that such a surface coating is best suited to exhibit the desired properties. Tungsten carbide is also a composition that is currently preferred as material for the surface coating.

According to another feature of the present invention, the surface coating may be realized in the form of a thermal spray-coated layer. Of course, other forms of applications are conceivable as well, although the provision of a spray-applied layer is currently preferred because of its efficiency and assurance to realize a high-quality surface coating which provides the desired surface roughness.

According to another feature of the present invention, the surface coating may have a thickness between 0.01 and 1.00 mm. Currently preferred is a thickness of about 0.2 mm.

In addition to the metallic surface coating of the gripping surfaces, a further improvement of the load-carrying device according to the present invention can be realized by swingably supporting the fixed jaw for movement in the housing. In this way, the fixed jaw is able to adjust to a swaying of the plate during lifting, transport or lowering in a controlled manner. The swingable support of the fixed jaw avoids undesired lever ratios as well as corresponding movements by the clamping jaw that may cause the plate to be pushed out. Thus, safety as well as handling is improved and risk of damage to the plate, e.g. by denting or scratching, is prevented.

According to another feature of the present invention, the profiled surface of the fixed jaw may have concentric ridges to further enhance gripping properties. The profiled surface of the clamping jaw may hereby have straight teeth. In this way, the teeth of the clamping jaw extend transversely to the pull direction and clamp the plate against the fixed jaw. The concentric ridges of the gripping surface of the fixed jaw support the plate under conditions that best conform to the load while distributing the surface pressure. In combination with the surface pressure, this construction prevents denting of the plate during lifting while still safely clamping the plate.

According to another feature of the present invention, the housing may be made of two forged housing portions. Such housing is characterized by high stability and torsional rigidity. This is especially effective in those cases when the load cannot be clamped in midsection.

According to another feature of the present invention, a shackle may be provided with a shackle body having opposite flat sides and a head portion formed with a hook eye, with the shackle body being formed with ribbed elevations jutting out beyond the flat sides. The ribbed elevations assume the function of spacers between both flat sides of the housing. As a result, swinging or rotary movements during handling of the load-carrying device can be reduced.

### BRIEF DESCRIPTION OF THE DRAWING

Other features and advantages of the present invention will be more readily apparent upon reading the following description of currently preferred exemplified embodiments of the invention with reference to the accompanying drawing, in which:

FIG. 1 is a perspective illustration of a load-carrying device according to the present invention;

FIG. 2 is a perspective illustration of a fixed jaw of the load-carrying device of FIG. 1; and

FIG. 3 is a perspective illustration of a clamping jaw of the load-carrying device of FIG. 1.

### DETAILED DESCRIPTION OF PREFERRED EMBODIMENTS

Throughout all the Figures, same or corresponding elements are generally indicated by same reference numerals. These depicted embodiments are to be understood as illustrative of the invention and not as limiting in any way. It should also be understood that the drawings are not necessarily to scale and that the embodiments are sometimes illustrated by graphic symbols, phantom lines, diagrammatic representations and fragmentary views. In certain instances, details which are not necessary for an understanding of the present invention or which render other details difficult to perceive may have been omitted.

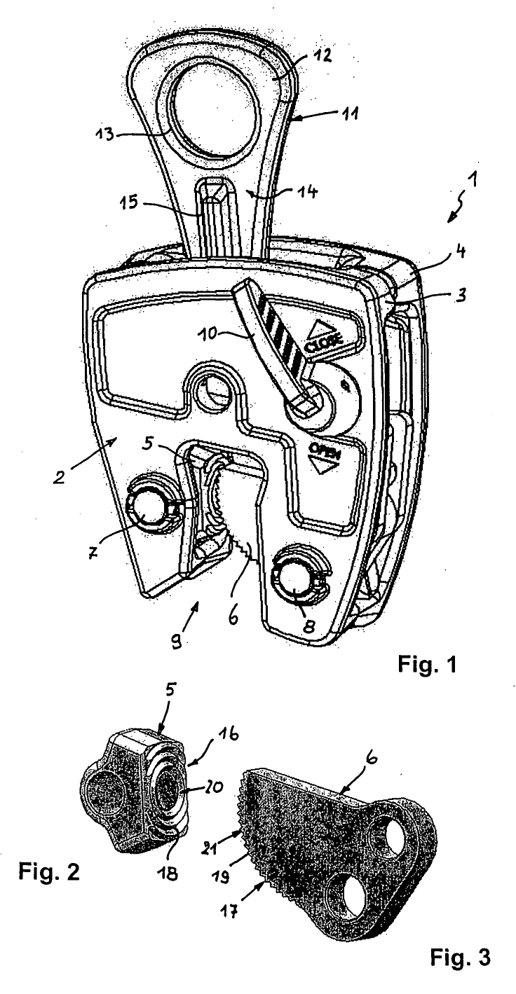

Turning now to the drawing, and in particular to FIG. 1, there is shown a perspective illustration of a load-carrying device according to the present invention, generally designated by reference numeral 1 and configured in the form of a plate gripper for gripping plates. The plate gripper 1 includes a stable housing 2 which is made essentially of two forged housing portions 3, 4. Supported in the housing 2 on pins 7, 8 between the housing portions 3, 4 are a fixed jaw 5 and a clamping jaw 6 which extend transversely across the housing 2 and define a mouth 9 to receive the article, e.g. a sheet metal plate, to be lifted and transported. The plate gripper 1 is hereby lowered from above onto a longitudinal edge or transverse edge of the article so that the edge region of the plate is clamped in the mouth 9 between the fixed and clamping jaws 5, 6. Clamping action is realized by operating a bar 10 which is pivoted via a lever arm (not visible here) of the clamping jaw 6 and shifted in the direction of the fixed jaw 5. As a result, the plate gripper 1 is biased upon the plate.

The plate gripper 1 further includes a shackle, generally designated by reference numeral 11 having a shackle body 12 whose upper free end is formed with a hook eye 13. The shackle 10 of the plate gripper 1 is pulled by a hoisting device, e.g. a crane, which hooks onto the hook eye 13 in order to transport the plate. The shackle 10 is hereby moved relative to the housing 2 of the plate gripper 1 together with an unillustrated pin which is supported in the housing 2 and displaced in an unillustrated slot extending in lifting direction. As a consequence of this movement, the clamping jaw 6 is pulled via a link (not shown) and moved, substantially perpendicular to the lifting direction, to the opposite fixed jaw 5 so that the plate is firmly clamped between the fixed jaw 5 and the clamping jaw 6. The clamping jaw 6 is formed eccentrically so as to realize a self-locking action.

The shackle body 12 of the shackle 10 is formed on both flat sides with ribbed elevations 15 which serve as spacers between the housing 2 and the shackle body 12 to prevent a back-and-forth rocking of the shackle 10 during handling of the plate gripper 1.

The fixed jaw 5 is swingably supported on the pin 7 in the housing 2. In this way, the fixed jaw 5 is able to adjust to any pivoting or tilting motions of the plate to thereby inhibit any undesired lever ratios and shift of the clamping jaw 6 as a result of a plate movement. The mouth 9 of the plate gripper 1 is enlarged on its innermost end to enable the plate being lifted to carry out a limited swinging movement in the absence of any support of the plate on the housing 2 which can lead to a lever action.

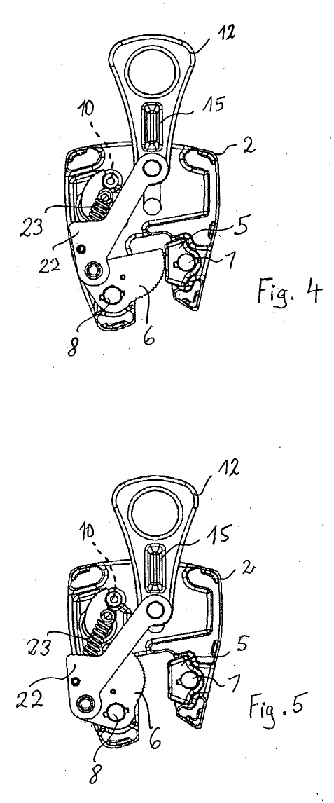

The fixed jaw 5 is provided with a profiled gripping surface 16 and the clamping jaw 6 is provided with a profiled gripping surface 17, as shown in FIGS. 2 and 3, respectively. As shown in FIG. 2, the gripping surface 16 of the fixed jaw 5 is provided with concentric ridges 18, whereas the gripping surface 19 of the clamping jaw 6 is arcuate and has straight teeth 19 which extend transversely across the width of the clamping jaw 6.

The gripping surface 16 of the fixed jaw 5 is provided with a metallic surface coating 20, and the gripping surface 17 of the clamping jaw 6 is provided with a metallic surface coating 21. Both surface coatings 20, 21 are applied on the gripping surfaces 16, 17 in the form of a thermal spray-coated layer. Each of the surface coatings 20, 21 contains metal or metal carbide selected from the group consisting of molybdenum (Mo), tungsten (W), chromium (Cr), nickel (Ni), cobalt (Co) at a fraction of at least 50% by weight, preferably between 80% by weight and 95% by weight, at a thickness between 0.01 and 1.00 mm.

Currently preferred is the configuration of the surface coatings 20, 21 to contain molybdenum (Mo) at a fraction of at least 50% by weight, preferably about 90% by weight, at a thickness of about 0.2 mm. The surface coatings 20, 21 have hereby a hardness of about 60 HRC and provides the plate gripper 1 and its fixed and clamping jaws 5, 6 with a surface roughness and coefficient of friction that positively affect the gripping characteristics to enable the plate gripper 1 to securely lift and transport even plates of very hard steel, or special steel, or oily or greasy plates, or plates with polished or varnished surface, under condition that best conform to the load being lifted and transported.

While the invention has been illustrated and described in connection with currently preferred embodiments shown and described in detail, it is not intended to be limited to the details shown since various modifications and structural changes may be made without departing in any way from the spirit of the present invention. The embodiments were chosen and described in order to best explain the principles of the invention and practical application to thereby enable a person skilled in the art to best utilize the invention and various embodiments with various modifications as are suited to the particular use contemplated.

What is claimed as new and desired to be protected by Letters Patent is set forth in the appended claims and includes equivalents of the elements recited therein:

1. A load-carrying device, in particular a plate gripper for vertical transport of a plate, comprising:
a housing;
a fixed jaw received in the housing and having a profiled gripping surface; and
a clamping jaw supported in the housing for movement relative to the fixed jaw and having a profiled gripping surface,
wherein the gripping surfaces of the fixed and clamping jaws are each provided with a metallic surface coating containing at least one metal or metal carbide selected from the group consisting of molybdenum (Mo), tungsten (W), chromium (Cr), nickel (Ni), cobalt (Co) of at least 50% by weight.

2. The load-carrying device of claim 1, wherein the fixed and clamping jaws have a base material made of case-hardened steel of a hardness of 55 to 58 HRC.

3. The load-carrying device of claim 1, wherein the surface coating has a hardness of at least 60 HRC.

4. The load-carrying device of claim 1, wherein the fraction of metal is between 80% by weight and 95% by weight.

5. The load-carrying device of claim 1, wherein the fraction of metal is 90% by weight.

6. The load-carrying device of claim 1, wherein the surface coating is a thermal spray-coated layer.

7. The load-carrying device of claim 1, wherein the surface coating has a thickness between 0.01 and 1.00 mm.

8. The load-carrying device of claim 1, wherein the surface coating has a thickness of about 0.2 mm.

9. The load-carrying device of claim 1, wherein the fixed jaw is swingably supported on a pin in the housing to allow the fixed jaw to adjust to a position of a grabbed plate.

10. The load-carrying device of claim 1, wherein the profiled surface of the fixed jaw has concentric ridges.

11. The load-carrying device of claim 1, wherein the profiled surface of the clamping jaw has an arcuate configuration formed with straight teeth.

12. The load-carrying device of claim 1, wherein the housing is made of two forged housing portions.

13. The load-carrying device of claim 1, and further comprising a shackle having a shackle body with opposite flat sides and a head portion formed with a hook eye, said shackle body being formed with ribbed elevations jutting out beyond the flat sides.

14. A load-carrying device for transport of a plate, comprising:
a housing;
a fixed jaw received in the housing and having a profiled gripping surface; and
a clamping jaw supported in the housing for movement relative to the fixed jaw and having a profiled gripping surface,
wherein the gripping surfaces of the fixed and clamping jaws are each provided with a surface coating containing molybdenum or a molybdenum alloy of at least 50% by weight.

15. The load-carrying device of claim 14, wherein the surface coating contains a molybdenum fraction of about 90% by weight.

16. A load-carrying device for transport of a plate, comprising:
a housing;
a fixed jaw received in the housing and having a profiled gripping surface; and
a clamping jaw supported in the housing for movement relative to the fixed jaw and having a profiled gripping surface,
wherein the gripping surfaces of the fixed and clamping jaws are each provided with a surface coating containing tungsten carbide of at least 50% by weight
